(19) United States
(12) Patent Application Publication
(10) Pub. No.: US 2023/0271557 A1
(43) Pub. Date: Aug. 31, 2023

(54) VEHICLE STEP SYSTEM

(71) Applicant: UNICELL LIMITED, East York (CA)

(72) Inventors: Roger MARTIN, Toronto (CA); Hugh MARTIN, Toronto (CA); Karel CASLAVSKY, Toronto (CA)

(21) Appl. No.: 18/014,384

(22) PCT Filed: Oct. 5, 2021
(86) PCT No.: PCT/CA2021/051394

§ 371 Date: Jan. 4, 2023

Related U.S. Application Data
(60) Provisional application No. 63/088,410, filed on Oct. 6, 2020.

(51) Int. Cl. B60R 3/02

(52) U.S. Cl. CPC B60R 3/02

(57) ABSTRACT

A cargo vehicle comprises stairs extending downwardly from a walk-though door of a cargo compartment. A primary step is fixedly positioned on the vehicle and a secondary step is movable between a deployed position below the primary step and a withdrawn position adjacent an underside of said cargo vehicle. Movement of the secondary step is caused by a powered linkage supporting the secondary step, operated by a controller operable to automatically move the secondary step based on an operating condition of the cargo vehicle.

### RELATED APPLICATIONS

This claims priority from U.S. provisional patent application no. 63/088,410, filed Oct. 6, 2020, the entire contents of which are incorporated herein by reference.

### FIELD

This relates to cargo vehicles, and in particular, to systems for entry and exit of cargo vehicles.

### BACKGROUND

Most applications of cargo vehicles require operators or workers to frequently enter and exit vehicles. The safety and productivity of workers using cargo vehicles is dependent on ease of safe entry and exit.

A major application of cargo vehicles is delivery of goods, packages and the like. Economic and technological developments have led to increasing demand for courier-type package deliveries, also referred to as “last mile” deliveries. Generally, such activity is characterised by delivery of small packages which can be manually carried by a vehicle operator. Unfortunately, existing cargo vehicle designs make entering and exiting vehicles cumbersome for such deliveries.

There is a need for improved vehicle entry and exit systems.

### SUMMARY

An example cargo vehicle comprises: a door permitting ingress to and egress from a cargo compartment; a primary step fixedly positioned on the vehicle adjacent the door; a secondary step in a deployed position below the primary step to define a descending walkway from the cargo compartment to ground; a powered linkage supporting the secondary step on the cargo vehicle in the deployed position, the linkage movable to retract the secondary step to a withdrawn position; a controller to automatically cause the powered linkage to move the secondary step between the deployed position and the retracted position.

An example exit system for a cargo vehicle comprises: a primary step fixedly positioned on the vehicle adjacent a door providing access to a cargo compartment; a secondary step in a deployed position below the primary step to define a descending walkway from the cargo compartment to ground; a powered linkage supporting the secondary step on the cargo vehicle in the deployed position, the linkage movable to retract the secondary step to a withdrawn position; a controller to automatically cause the powered linkage to move the secondary step between the deployed position and the retracted position.

An example cargo vehicle comprises: a door permitting ingress to and egress from a cargo compartment; a primary step fixedly positioned on the vehicle adjacent the door; a secondary step in a deployed position below the primary step to define a set of stairs extending from the cargo compartment towards the ground; a motorized linkage supporting the secondary step on the cargo vehicle and operable to move the secondary step between the deployed position, and a withdrawn position adjacent an underside of the cargo vehicle; a controller operable to automatically cause the motorized linkage to move the secondary step between the deployed and withdrawn positions based on an operating condition of the cargo vehicle.

Other aspects will be apparent from the disclosure herein.

### BRIEF DESCRIPTION OF DRAWINGS

In the figures, which depict example embodiments:

FIG. 1 is an isometric view of a cargo vehicle;

FIGS. 2A and 2B are enlarged isometric views of a cargo area of the vehicle of FIG. 1, with a rear door closed and open, respectively;

FIG. 3A is an enlarged schematic side view of a set of stairs of the cargo vehicle of FIG. 1;

FIG. 3B is an enlarged isometric view of the underside of the cargo vehicle of FIG. 1, showing a step, linkage and drive system;

FIG. 4 is an enlarged schematic side view of the cargo vehicle of FIG. 1, with a lower-most step in a deployed position;

FIG. 5 is an enlarged schematic side view of the cargo vehicle of FIG. 1, with a lower-most step in a retracted position;

FIG. 6 is a block diagram of a control system at the cargo vehicle of FIG. 1;

FIG. 7 is a diagram showing operating states of a controller of the system of FIG. 6;

FIGS. 8A-8B are enlarged schematic side views of a cargo vehicle with an alternate linkage, showing a lower-most step in deployed and retracted positions, respectively;

FIGS. 9A-9B are enlarged isometric views of the underside of a cargo vehicle with an alternate linkage, showing a lower-most step in deployed and retracted positions, respectively;

FIGS. 10A-10B are enlarged schematic side views of the cargo vehicle of FIGS. 9A-9B, showing a lower-most step in deployed and retracted positions, respectively; and

FIGS. 11A-11B are isometric views of a cargo area of a cargo vehicle, including safety guards adjacent a set of stairs.

### DETAILED DESCRIPTION

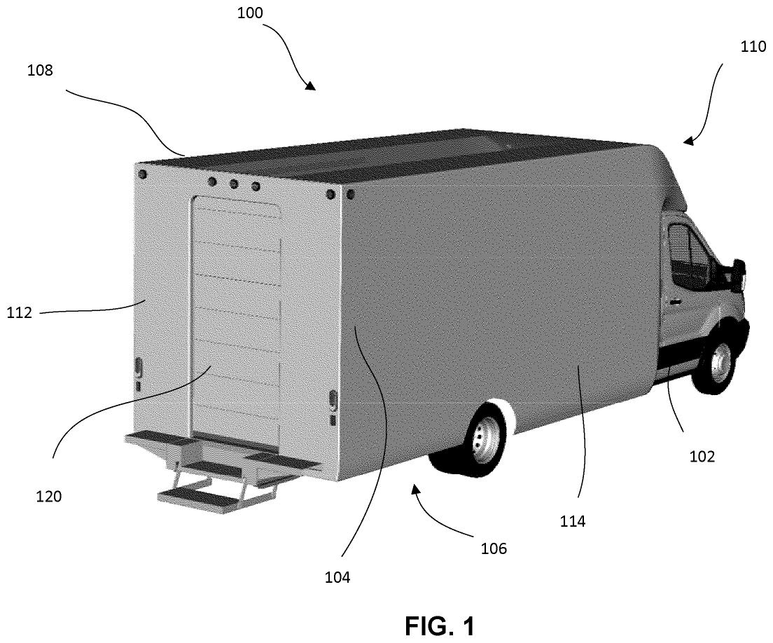

FIG. 1 is a schematic diagram of an example cargo vehicle 100. Cargo vehicle 100 has a cab 102, for operation of the vehicle, and a cargo compartment 104, for receiving cargo.

In the depicted example, cargo vehicle 100 is a delivery vehicle, and cargo received in cargo compartment 104 comprises a plurality of packages to be delivered. Cargo vehicle 100 includes systems for providing convenient ingress to and egress from cargo compartment 104. In particular, cargo vehicle 100 includes a full-height walkthrough door and a walkway so that personnel can comfortably walk from an elevated cargo floor to ground and vice-versa.

The walkway includes a plurality of steps, including a movable step. In a deployed position, the movable step forms part of a descending walkway to permit comfortable passage. The step may be moved to a retracted position, in which the step is positioned close to the body of the cargo vehicle to allow unobstructed driving of the vehicle. Movement between the deployed and withdrawn positions may be automated for efficiency of operation.

In operation, cargo vehicle 100 is driven along a delivery route comprising a plurality of stops. One or more packages may be removed from cargo compartment 104 and delivered at each stop.

Packages delivered in this manner may be sized so that they can be carried by hand by an individual worker (hereinafter referred to as an operator). Typically, a single operator is responsible for both driving cargo vehicle 100 and making deliveries. Efficiency of such activities may depend on the speed and ease with which an operator can move from cab 102 to cargo compartment 104, pick up a package to be delivered, exit cargo vehicle 100 and deliver the package, and return to cab 102 to resume driving.

Example embodiments herein are described by reference to cargo vehicle 100 used for shipping. However, it should be understood that other applications are possible. For example, cargo vehicle 100 may be used as a mobile service vehicle. In such cases, tools and parts may be stored in cargo compartment 104. Other applications will be apparent.

Cargo compartment 104 is defined by a van body having a bottom side 106, a van roof 108, front and rear walls 110, 112 and opposing side walls 114. Rear wall 112 has a rear door 120, through which an operator can enter and exit cargo compartment 104. An interior door (not shown) may be present between cab 102 and cargo compartment 104, for passage of an operator from cab 102 to cargo compartment 104 and vice-versa. The van body may be of any suitable construction. In an example, the van body is a one-piece fiberglass shell.

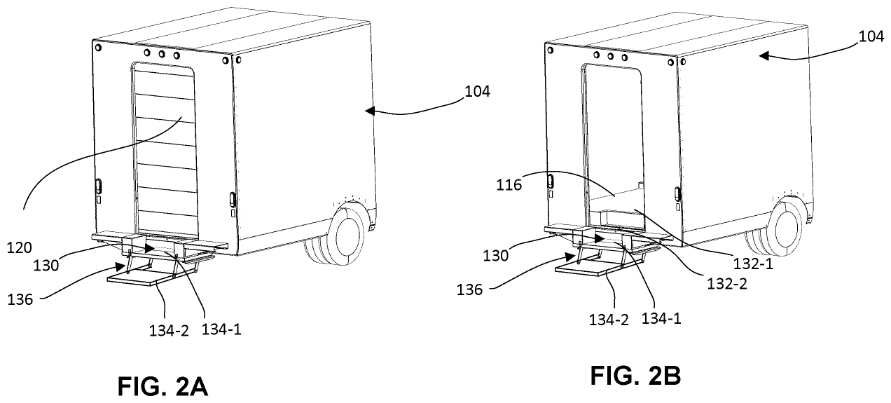

FIGS. 2A-2B are partial isometric views showing cargo compartment 104 in greater detail, with rear door 120 closed and open, respectively.

Rear door 120 is a full-height walk-through door. That is, rear door 120 is sized such that, when open, an operator can walk through rear door 120 in an upright position. In the depicted embodiment, rear door 120 is a retractable overhead door. However, other types of door may be used. For example, rear door 120 may swing outwardly about a vertical hinge, or rear door 120 may be a horizontally-sliding door such as a barn-style door or a pocket door.

As shown in FIG. 2B, cargo compartment 104 has an internal floor 116 that is elevated relative to the ground on which cargo vehicle 100 is supported. In the depicted example, the van floor is approximately 30 inches above the ground. Accordingly, in order for an operator to exit cargo compartment 104 through rear door 120, the operator must descend to the ground.

Cargo vehicle 100 has a descending walkway, leading through rear door 120 and upon which an operator can walk to descend from cargo vehicle 100 to ground. In the depicted embodiment, the descending walkway is a set of stairs 130.

The set of stairs 130 has internal steps 132-1, 132-2 (individually and collectively, internal steps 132) leading to rear door 120 on the interior of cargo vehicle 100, and external steps 134-1, 134-2 (individually and collectively, external steps 134) outside cargo vehicle 100 and leading from rear door 120 to ground. Stairs 130 divide the vertical drop from internal floor 116 to ground into smaller steps which can be comfortably traversed by an operator in an upright position.

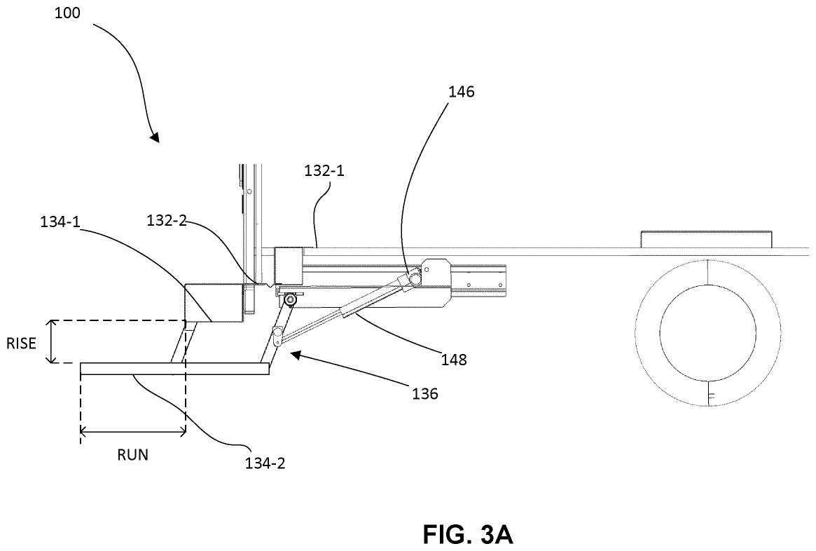

FIG. 3A is an enlarged simplified side view of stairs 130, showing an example configuration thereof. As shown, the individual steps are spaced from one another according to a rise and run. The rise is defined as a vertical distance between adjacent steps, and the run is defined as a horizontal distance between adjacent steps. In the depicted example, each step has a rise of seven inches and a run of ten inches. However, other configurations are possible. The rise and run may be configured to provide an ergonomically acceptable walkway based on the size and nature of objects an operator is expected to carry through rear door 120. For example, the rise between steps may be short for vehicles intended to carry large or heavy parcels, and the rise between steps may be longer for vehicles intended to carry smaller, lighter objects such as hand tools.

In the depicted embodiment, the set of stairs 130 includes two internal steps 132 and two external steps 134. However, more or fewer steps may be present, depending on the dimensions of cargo vehicle 100. For example, in the depicted embodiment, internal floor 116 of cargo compartment 104 is raised relative to rear door 120. However, in other embodiments, internal floor 116 may be less raised or may not be raised at all. In such cases, fewer internal steps may be needed.

External steps 134 include a stationary step 134-1 and a movable step 134-2. Stationary step 134-1 is mounted fixedly to cargo vehicle 100, adjacent rear door 120. Movable step 134-2 is positioned below stationary step 134-1 and is supported on cargo vehicle 100 via a linkage 136.

FIG. 3B is an enlarged isometric view of the underside of cargo vehicle 100, showing linkage 136 in greater detail. As shown, linkage 136 is a four-bar linkage, defined by stationary step 134-1 and movable step 134-2 and a pair of front links 138 parallel to one another and a pair of rear links 140 parallel to one another. Links 138, 140 are pivotably coupled to steps 134-1, 134-2 at joints 141. Each joint permits relative rotation, such that rotation of links 138, 140 relative to step 134-1 causes movement of step 134-2.

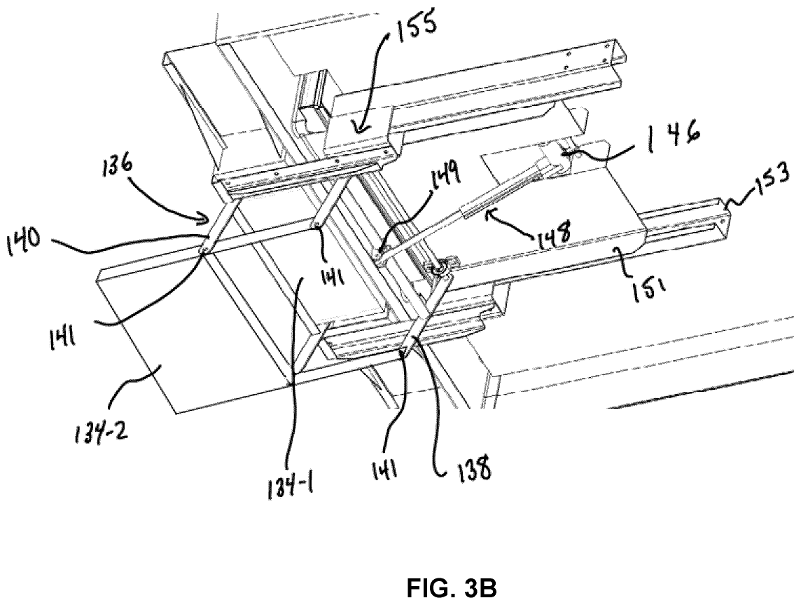

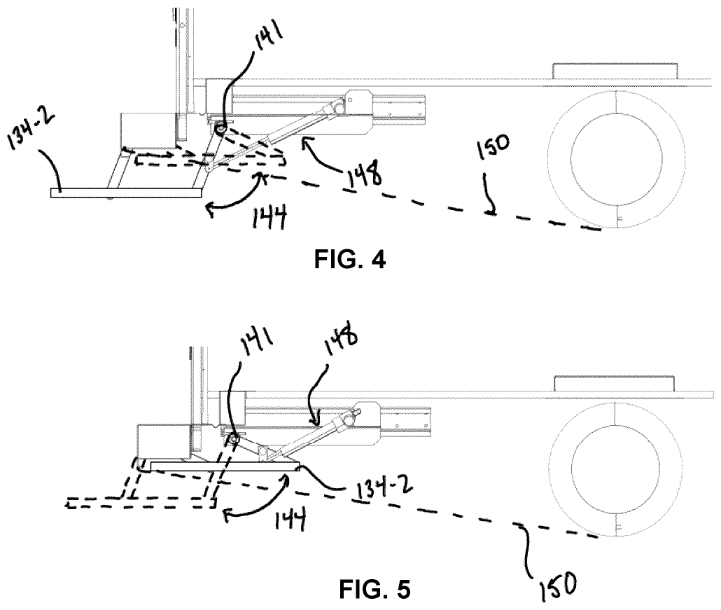

Linkage 136 is movable between a first position, shown in FIG. 4, in which movable step 134-2 is deployed to form part of the set of stairs 130, and a second position, shown in FIG. 5, in which movable step 134-2 is in a withdrawn position closer to the body of cargo vehicle 100.

Linkage 136 is equipped with a drive mechanism to power movement of movable step 134-2 between its deployed and withdrawn positions. As depicted, the drive mechanism includes an electric motor 146 coupled to link 138 by a linear actuator 148 at a crank 149. Extension or retraction of linear actuator 148 causes linkage 136 to pivot about stationary step 134-1. The drive mechanism is self-locking. That is, electric motor 146 locks linear actuator 148 in place such that the motor resists movement of movable step 134-2 by application of external force to the step. The locking of electric motor 146 and linear actuator 148 thus supports external step 134-2 in place to bear the weight of an operator. Additionally or alternatively, a bracing mechanism may be provided. For example, a locking device may be deployed when movable step 134-2 reaches either of its deployed or retracted positions. The locking device may physically interfere with movement of linkage 136, locking the linkage and movable step in place.

In other embodiments, drive mechanisms other than electric motors may be used. For example, linear drive mechanisms such as hydraulic or pneumatic cyclinders may be substituted for electric motor 146 and linear actuator 148. However, electric drive mechanisms typically have certain advantages over hydraulic and pneumatic drive mechanisms. For example, electric drive mechanisms can easily be powered as an accessory to the main engine of cargo vehicle 100. That is, an electrical drive mechanism may be powered by electrical current from an alternator or battery associated with the engine. In contrast, hydraulic and pneumatic drives require further auxiliary devices such as pumps or compressors, to provide pressurized fluid. In addition, electrical drive mechanisms may allow for more robust sealing against the operating environment, which may in turn provide greater durability.

Other types of drive mechanism are possible. For example, the drive mechanism may include an electric motor with a rotary output shaft rotationally coupled to linkage 136, such that the electric motor can directly cause rotation of linkage 136. Such rotational coupling, may, for example, be by way of a gearset.

Linkage 136 and its drive mechanism are mounted to a support plate 151 which is in turn mounted to frame rail extensions 153. Alternatively, support plate 152 may be mounted directly to integral frame members of cargo vehicle 100. An auxiliary beam 155 may also be mounted to frame rail extensions 153, and support stationary step 134-1.

FIGS. 4-5 depict motion of step 134-2. FIG. 4 depicts step 134-2 in the deployed position, with the retracted position shown in broken line. FIG. 5 depicts step 134-2 in the retracted position, with the deployed position shown in broken line.

Each joint 141 at step 134-2 travels in an arc 144 as it moves between the deployed and retracted positions. The arc is defined by the geometry of linkage 136, i.e. the shapes and sizes of links 138, 140 and the positions of joints 141. Preferably, linkage 136 is configured to allow clearance between step 134-2 and ground, at the lowest point of arc 144.

In the depicted embodiment, front links 138 and rear links 140 are straight. However, in some embodiments, each of links 138, 140 may be straight, curved or kinked in a dog-leg shape.

Vehicle 100 has an angle of departure 150, which defines the maximum incline or decline of a ramp cargo vehicle 100 can traverse without its body contacting the ground.

In the absence of movable step 134-2, the angle of departure 150 is defined by a line from a point of contact between the ground and a tire 154 on the rear-most axle of vehicle 100, to the lowest-hanging portion of the body of vehicle 100.

As is apparent from FIG. 4, in the deployed position of step 134-2, movable step 134-2 is below the departure angle 150. Thus, in the deployed position, movable step 134-2 would interfere with the ability of vehicle 100 to traverse ramps without contact.

Conversely, in the retracted position of step 134-2 (FIG. 5), the step 134-2 is above the angle of departure 150. Accordingly, step 134-2, in its retracted position, does not interfere with the ability of cargo vehicle 100 to traverse ramps.

Likewise, in the depicted embodiment, linkage 136 is above the departure angle 150 while movable step 134-2 is in its retracted position. Thus, in this state, linkage 136 would not interfere with the ability of cargo vehicle 100 to traverse ramps.

Movable step 134-2 may therefore be selectively deployed when it is required for personnel to enter and exit cargo vehicle 100 through rear door 120, and stowed in its retracted position when cargo vehicle 100 is driven between locations. This may avoid damage to step 134-2 or interference with operation of cargo vehicle 100.

Movement of step 134-2 between deployed and retracted positions may be automatic. For example, such movement may be caused by a controller in response to an operating state of cargo vehicle 100.

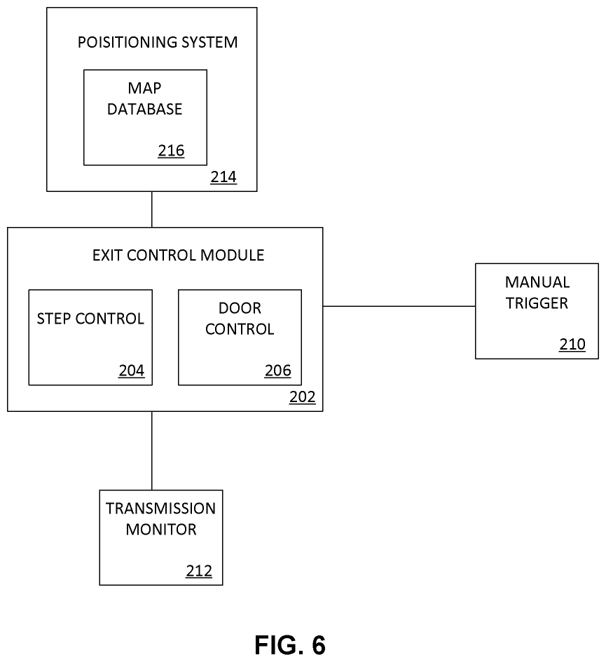

FIG. 6 schematically depicts a control system 200 within cargo vehicle 100. Control system 200 is operable to selectively move movable step 134-2 between its deployed and retracted positions and to selectively open and close rear door 120.

Control system 200 includes an exit control module 202. Exit control module 202 has a step controller 204 in communication with electric motor 146 and operable to selectively activate the electric motor to deploy or retract step 134-2. Exit control module 202 further includes a door controller 206 in communication with a door opening drive and operable to selectively cause rear door 120 to be opened or closed by way of the drive.

Exit control module 202 may be a microcontroller. For example, the control module 202 may be a microcontroller with a housing suitably robust for automotive application. Alternatively, exit control module 202 may be implemented in software executed on a general-purpose computing device. Although step controller 204 and door controller 206 are depicted as separate components, they may instead occupy separate channels of a single controller.

Exit control module 202 is in communication with a manual trigger 210, a transmission monitor 212 and a vehicle positioning system 214. Communication may be by way of a wired connection such as a universal serial bus (USB) or controller area network (CAN bus) at vehicle 100, or by a suitable wireless connection such as a Bluetooth or Wi-Fi connection, or any combination thereof.

Manual trigger 210 comprises a control input such as a switch or button, operable while cargo vehicle 100 is being driven, by the vehicle's driver. Trigger 210 may, for example, be a button positioned on an instrument panel (IP) within cab 102 of vehicle 100.

Manual trigger 210 is configured to send an activation signal to exit control module 202 when the trigger is actuated. Trigger 210 may, for example, be a toggle, and upon actuation, may send an activation signal causing the exit control module 202 to deploy step 134-2 and open rear door 120.

Transmission monitor 212 is configured to detect and send signals to exit control module 202 indicative of a state of the transmission of cargo vehicle 100, such as a selected gear and operating speed. Transmission monitor 212 may be a module connected to a controller area network (CAN bus) at vehicle 100, and may determine operating states based on signals from an engine control unit (ECU). Alternatively, transmission monitor 212 may communicate directly with control circuitry of the transmission of cargo vehicle 100.

Positioning system 214 is operable to determine a geographical position of cargo vehicle 100. Positioning system 214 may for example be a satellite-based system such as a Global Positioning System (GPS) or Global Navigation Satellite System (GLONASS) device or the like. Positioning system 214 may additionally or alternatively derive location information from network sources, such as a location within a cellular communication network.

Positioning system 214 may include a map database 216. Map database 216 includes map data descriptive of the operating area of cargo vehicle 100, e.g. a state, province, geographical territory or the like. Map database 216 may also include route data defining one or more transit routes to be travelled by cargo vehicle 100. Such routes may, for example, be defined by a sequence of GPS co-ordinates that correspond to a sequence of deliveries to be performed using cargo vehicle 100.

Positioning system 214 is configured periodically or continuously compare the position of vehicle 100 to the coordinates of delivery points. When cargo vehicle 100 is within a defined proximity to a delivery point, positioning system 214 may provide an activation signal to exit control module, indicating that the vehicle 100 is positioned at a location where an operator may need to exit. Proximity may be defined as a threshold distance or a threshold transit time. Positioning system 214 may also be configured to send a de-activation signal to exit control module 202 when vehicle 100 is no longer within the defined proximity of a delivery point.

Exit control module 202 is configured to automatically deploy or retract movable step 134-2 and to automatically open or close rear door 120 based on signals received from manual trigger 210, transmission monitor 212 and positioning system 214.

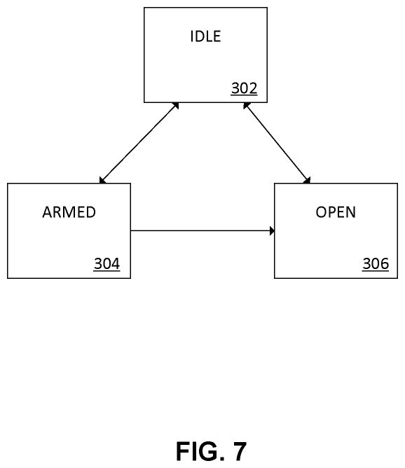

Exit control module 202 is operable in three states, depicted in FIG. 7, namely, an idle state 302, an armed state 304 and a deployed state 306. Step 134-2 is in its retracted position and door 120 is closed when exit control module 202 is in idle state 302 or armed state 304. Step 134-2 is deployed and door 120 is open when exit control module 202 is in its deployed state.

Automatic deployment of step 134-2 and opening of door 120 may be effected by arming exit control module 202 (i.e. transitioning exit control module 202 to armed state 302) in response to a first event, and then deploying step 134-2 and opening door 120 in response to a second event.

For example, exit control module 302 may be armed while cargo vehicle 100 is being drive, in response to actuation of manual trigger 210, and deployment may occur when the vehicle 100 is next parked. Thus, for example, an operator may actuate the manual trigger in advance of a stop, but deployment can be automatically delayed until conditions are safe, i.e. when the vehicle is parked.

In the idle state 302, exit control module 202 monitors signals from each of manual trigger 210 and positioning system 214. Such signals may prompt exit control module 202 to transition to an armed state.

Specifically, while in idle state 302, exit control module 202 interprets actuation of manual trigger 210 as an indication that a stop is anticipated at which an operator will need to exit vehicle 100 through rear door 120. Thus, exit control module 202 transitions from the idle state 302 to the armed state 304 in response to an activation signal indicating that manual trigger 210 has been activated.

While in idle state 302, exit control module 302 interprets an activation signal from positioning system 214 as an indication that vehicle 100 is approaching a location where it is known that an operator will need to exit vehicle 100 through rear door 120. Thus, exit control module 202 also transitions from the idle state 302 to the armed state 304 in response to an activation signal from positioning system 214 indicating that cargo vehicle 100 is in proximity to a delivery location.

If transmission monitor 212 indicates that vehicle 212 has been parked while exit control module is in idle state 302, the exit control module disregards the signal. For example, such a signal may occur if the vehicle is stopped at a location that does not require a delivery or does not otherwise require the operator to exit through rear door 120.

While exit control module 202 is in the armed state, parking of vehicle 100 is interpreted as indicating that step 134-2 should be deployed and rear door 120 should be opened. Thus, if exit control module 202 receives a signal from transmission monitor 212 indicating that cargo vehicle 100 has been parked, exit control module 202 sends a signal to the drive mechanism of linkage 136, causing movable step 134-2 to be moved to its deployed position. Likewise, exit control module 202 sends a signal to a drive mechanism of rear door 120 causing the door to be opened.

If exit control module 202 receives a deactivation signal from positioning system 214, indicating that cargo vehicle 100 has departed from a delivery location, exit control module transitions from the armed state 304 to the idle state 302.

Exit control module 202 may also exit the armed state 304 based on a timer. For example, exit control module 202 may be configured to exit the armed state if a defined period of time elapses in the armed state without deployment of step 134-2 and opening of door 120.

Such deactivation signals may, for example, occur if there is an error in the stored route or if an operator drives to an incorrect location. Automatic exiting of armed state 304 may guard against unintended deployment.

Upon deployment of step 134-2 and opening of rear door 120, exit control module 202 transitions to open state 306, in which it monitors for closing conditions.

Signals from transmission monitor 212 may be taken as closing conditions. For example, step 134-2 may be retracted and door 120 may be closed if the transmission of vehicle 100 is moved into a forward (drive) gear or if the vehicle operates above a threshold speed.

Expiry of a timer may also be taken as a closing condition. The timer may guard against an operator inadvertently leaving step 134-2 deployed or rear door 120 open. For example, closing and retraction may automatically occur after a defined waiting period. In some embodiments, only closing of rear door 120 is automated, and step 134-2 remains in a deployed position.

In addition to automated operation as described above, manual operation may be possible. That is, a control may be provided for an operator to immediately cause deployment and opening or retraction and closing of step 134-2 and door 120, regardless of the state of exit controller module 202. Concurrent with manual deployment, exit controller module 202 may be transitioned to deployed state 306. Concurrent with manual retraction, exit controller module 202 may be transitioned to idle state 302. Controls for manual operation may be located at an instrument panel within cab 102, in the interior of cargo compartment 104, or on the exterior of cargo compartment 104 proximate rear door 120, or any combination thereof. Manual operation may be restricted so that manual deployment and opening can only occur when cargo vehicle 100 is parked.

In some embodiments, exit control module 202 may control only deployment and retraction of step 134-2. Opening and closing of rear door 120 may be effected manually or by a different controller. Alternatively, exit control module 202 may independently control rear door 120 and deployment and retraction of step 134-2. For example, separate manual triggers 210 may be provided for rear door 120 and step 134-2 or automated operation of the door and the step may occur in response to different combinations of the above conditions.

In some embodiments, exit controller module 202 may have safety lockout features. For example, module 202 may communicate with one or more sensors for verifying that no obstruction is present. Such sensors may include, for example, optical sensors or torque or force sensors on the mechanism for driving linkage 136. Upon detection of an obstruction or detection of a force or torque spike indicating that step 134-1 has met resistance, a signal may be sent to controller module 202. In response, the module may reverse in-progress deployment or retraction of step 134-2, or may shift controller module 202 from armed state 304 to idle state 302.

In some embodiments, arming may be caused by manual controls. For example, a button or switch may be provided on the dash of cargo vehicle 100 that, upon actuation, arms controller 202. Opening of door 120 and deployment of step 120 may then occur when the transmission of cargo vehicle 100 is placed in park, or when another manual control is operated.

Controller 202 may further be configured to respond to signals from remote devices, such as key fobs. For example, a key fob may be configured to wirelessly transmit an arming signal to arm controller module 202, or to transmit an opening signal to cause opening of door 120 and deployment of step 134-2, or to transmit a closing signal to cause closing of door 120 and retraction of step 134-2, or any combination thereof. In some embodiments, signals from the fob may cause operation of only one of rear door 120 and step 134-2.

As described above, linkage 136 allows for movement of step 134-2 from the deployed position in which it forms part of stairs 130, to a retracted position under the body of vehicle 100. However, other linkage configurations are possible.

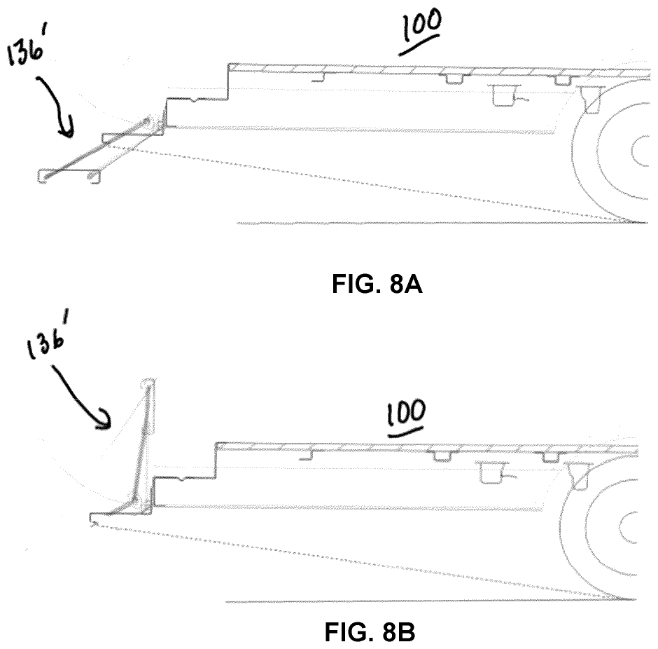

For example, FIGS. 8A-8B depict an alternate linkage 136′. Linkage 136′ permits movement of movable step 142 from a deployed position, shown in FIG. 8A, to a retracted position, shown in FIG. 8B. Linkage 136′ pivots upwardly from the deployed position to the retracted position, such that step 134-2 is positioned adjacent rear door 120 in the retracted position. Conveniently, this configuration provides ample clearance between ground and step 134-2. However, in its retracted position, step 134-2 obstructs rear door 120.

In some embodiments, step 134-2 may be mounted on a linkage that slides instead of or in addition to pivoting.

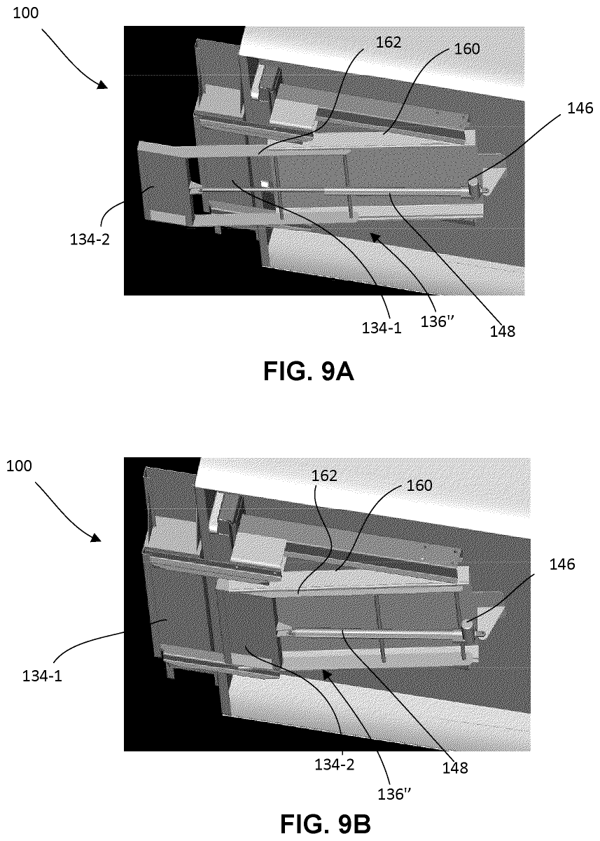

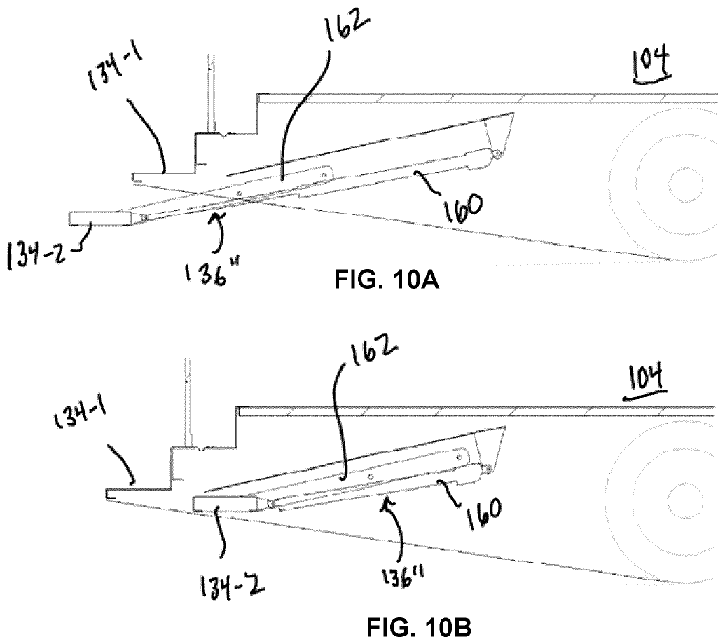

FIGS. 9A-9B and 10A-10B depict an example sliding linkage 136″ in isometric and simplified side views, respectively. Step 134-2 is shown in a deployed position in FIGS. 9A and 10A and in a retracted position in FIGS. 9B and 10B.

Sliding linkage 136″ includes a first track 160 mounted to the underside of cargo vehicle 100 and a second track 162 slidably mounted to first track 160. Second track 162 may be carried on rollers (not shown).

As depicted, sliding linkage 136″ is driven by an electric motor 146 and linear actuator 148. However, sliding linkage 136″ may alternatively be driven by a chain mechanism. A chain drive may accommodate a large travel between deployed and retracted positions, while maintaining a relatively compact overall size of the drive mechanism.

Conveniently, sliding linkage 136″ provides ample ground clearance. However, the sliding mechanism is more complicated than the pivoting mechanisms of linkages 136, 136′ and may be more susceptible to wear or damage.

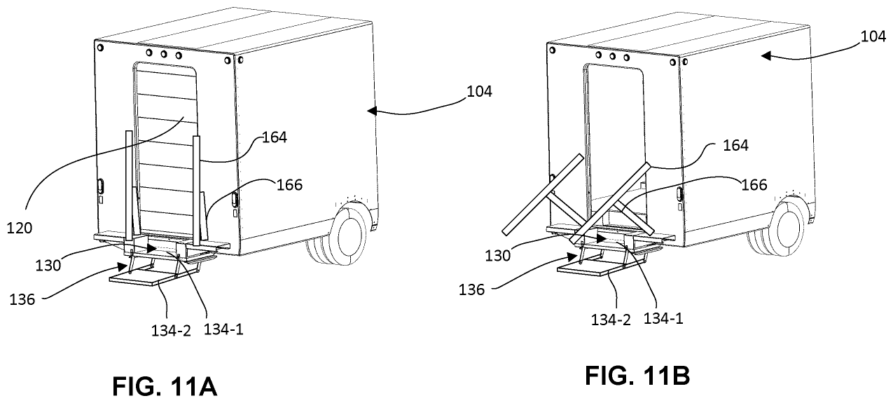

In some embodiments, the walkway defined by stairs 130 may further be equipped with safety guards such as handrails. FIGS. 11A-11B depict an example of such embodiment, in which handrails 162 are positioned adjacent stairs 130.

Each handrail 164 is slidably and pivotably attached to vehicle 100 adjacent rear door 120 and is supported by a support beam 166. The support beam is pivotably attached to handrail 164 and to the van body. Like step 134-2, handrail can be moved between deployed and retracted positions. FIG. 11A depicts a deployed position and FIG. 11B depicts a retracted position.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

1. A cargo vehicle comprising:
a. a door permitting ingress to and egress from a cargo compartment;
b. a primary step fixedly positioned on said vehicle adjacent said door;
c. a secondary step in a deployed position below said primary step to define a descending walkway from said cargo compartment to ground;
d. a powered linkage supporting said secondary step on said cargo vehicle in said deployed position, said linkage movable to retract said secondary step to a withdrawn position;
e. a controller to automatically cause said powered linkage to move said secondary step between said deployed position and said retracted position.

2. The cargo vehicle of claim 1, wherein said powered linkage is driven by an electric motor.

3. The cargo vehicle of claim 1, wherein said controller is configured to automatically cause said powered linkage to move said secondary step between said deployed position and said withdrawn position based on an operating condition of said vehicle.

4. The cargo vehicle of claim 1, wherein said controller is configured to automatically cause said linkage to move said secondary step between said deployed position and said withdrawn position in response to actuation of a manual control.

5. The cargo vehicle of claim 1, wherein said controller is configured to cause said motor to move said secondary step to said deployed position in response to a signal indicating a geographical location of said cargo vehicle.

6. The cargo vehicle of claim 1, wherein said controller is configured to automatically cause said motor to move said secondary step between said deployed position and said withdrawn position based on an operating state of a transmission of said cargo vehicle.

7. The cargo vehicle of claim 1, wherein said linkage pivotably attaches said secondary step to said vehicle.

8. The cargo vehicle of claim 1, wherein said linkage slidably attaches said secondary step to said vehicle.

9. The cargo vehicle of claim 1, wherein, in said deployed position, said primary and secondary steps define a set of stairs.

10. The cargo vehicle of claim 9, wherein said set of stairs further comprise a step inside said cargo compartment.

11. The cargo vehicle of claim 9, wherein said set of stairs has a rise between stairs of less than 8 inches.

12. The cargo vehicle of claim 1, wherein, in said retracted position, said secondary step lies above a plane defined by a departure angle of the cargo vehicle.

13. The cargo vehicle of claim 1, wherein said door is full-height walk-through door.

14. The cargo vehicle of claim 12, wherein said cargo vehicle has an internal passage from an operator cabin to said cargo compartment.

15. An exit system for a cargo vehicle comprising:
a. a primary step fixedly positioned on said vehicle adjacent a door providing access to a cargo compartment;
b. a secondary step in a deployed position below said primary step to define a descending walkway from said cargo compartment to ground;
c. a powered linkage supporting said secondary step on said cargo vehicle in said deployed position, said linkage movable to retract said secondary step to a withdrawn position;
d. a controller to automatically cause said powered linkage to move said secondary step between said deployed position and said retracted position.

16. The exit system of claim 15, comprising an electric motor for driving said linkage.

17. The exit system of claim 15, wherein said controller is configured to automatically cause said powered linkage to move said secondary step between said deployed position and said withdrawn position based on an operating condition of said vehicle.

18. The exit system of claim 15, wherein said controller is configured to automatically cause said linkage to move said secondary step between said deployed position and said withdrawn position in response to actuation of a manual control.

19. The exit system of claim 15, wherein said controller is configured to cause said motor to move said secondary step to said deployed position in response to a signal indicating a geographical location of said cargo vehicle.

20. The exit system of claim 15, wherein said controller is configured to automatically cause said motor to move said secondary step between said deployed position and said withdrawn position based on an operating state of a transmission of said cargo vehicle.

21. The exit system of claim 15, wherein said linkage pivotably attaches said secondary step to said vehicle.

22. The exit system of claim 15, wherein said linkage slidably attaches said secondary step to said vehicle.

23. The exit system of claim 15, wherein, in said deployed position, said primary and secondary steps define a set of stairs.

24. The exit system of claim 23, wherein said set of stairs further comprise a step inside said cargo compartment.

25. The exit system of claim 23, wherein said set of stairs has a rise between stairs of less than 8 inches.

26. The exit system of claim 15, wherein, in said retracted position, said secondary step lies above a plane defined by a departure angle of the cargo vehicle.

27. The exit system of claim 15, wherein said door is full-height walk-through door.

28. The exit system of claim 27, wherein said cargo vehicle has an internal passage from an operator cabin to said cargo compartment.

29. A cargo vehicle comprising:
a. a door permitting ingress to and egress from a cargo compartment;
b. a primary step fixedly positioned on said vehicle adjacent said door;
c. a secondary step in a deployed position below said primary step to define a set of stairs extending from said cargo compartment towards the ground;
d. a motorized linkage supporting said secondary step on said cargo vehicle and operable to move said secondary step between said deployed position, and a withdrawn position adjacent an underside of said cargo vehicle;
e. a controller operable to automatically cause said motorized linkage to move said secondary step between said deployed and withdrawn positions based on an operating condition of the cargo vehicle.

30.-37. (canceled)
